(19) United States
(12) Patent Application Publication
(10) Pub. No.: US 2026/0218856 A1
(43) Pub. Date: Jul. 30, 2026

(54) METHOD FOR DISTRIBUTING A MIXTURE IN A GASEOUS STATE

(71) Applicant: Air Liquide Electronics Systems, Paris (FR)

(72) Inventors: Frederic LORAY, Jarrie (FR); Adrien LEGALLET, Echirolles (FR); Francois QUERS, Echirolles (FR)

(21) Appl. No.: 19/454,971

(22) Filed: Jan. 21, 2026

(30) Foreign Application Priority Data
Jan. 24, 2025 (FR) FR2500787

(51) Int. Cl. F17C 5/06

(52) U.S. Cl. CPC F17C 5/06; F17C 2221/03; F17C 2223/0115; F17C 2223/0123; F17C 2227/0302; F17C 2227/036

(57) ABSTRACT

System (1) for distributing a mixture, comprising a transfer circuit (3) designed to be connected by one of its ends to a source (12) of a mixture and by another of its ends to an enclosure (6); a first heating element (4); a second heating element (40); a first expansion element (8); a second expansion element (9); a third expansion element (10); the system (1) being configured so that, in the direction of flow of the mixture in the transfer circuit (3), the mixture is successively heated by the first heating element (4), expanded by the first expansion element (8), heated by the second heating element (40), expanded by the second expansion element (9) and expanded by the third expansion element (10).

### CROSS REFERENCE TO RELATED APPLICATIONS

This application claims the benefit of priority under 35 U.S.C. § 119 (a) and (b) to French Patent Application No. FR2500787, filed Jan. 24, 2025, the entire contents of which are incorporated herein by reference.

### BACKGROUND

The present invention relates to a system for distributing a mixture and to a method for distributing such a mixture.

Document FR3054018 describes a method for distributing a mixture to high-or medium-voltage electrical equipment.

Such electrical equipment is used, for example, in high-or medium-voltage power transmission lines or high-or medium-voltage distribution substations.

High- or medium-voltage gas-insulated distribution substations are known as gas-insulated substations (GIS).

High- or medium-voltage gas-insulated lines are known as gas-insulated lines (GIL).

In this description, the term high voltage refers to a voltage that is strictly greater than 52 kV in alternating current and can reach 800 kV or more, and the term medium voltage refers to a voltage between 10 kV and 52 kV in alternating current.

In this description, the term storage device refers to a container capable of holding a gas or mixture in a liquid and/or gaseous and/or supercritical state, such as a gas cylinder or container.

Currently, the gas most often used in this type of equipment is sulphur hexafluoride (SF₆). This gas has a relatively high dielectric strength, good thermal conductivity and low dielectric losses. It is chemically inert and non-toxic to humans and animals and, after being dissociated by an electric arc, it recombines rapidly and almost completely. In addition, it is non-flammable and can still be obtained at a moderate price. However, SF₆ has the major disadvantage of having a global warming potential (GWP) of 22,200 (relative to CO₂ over 100 years) and a residence time in the atmosphere of 3,200 years, which makes it one of the most potent greenhouse gases.

SF₆ was therefore included by the Kyoto Protocol (1997) on the list of gases of which the emissions must be limited. The European Commission has also established a timetable for the phasing out of this gas in high-and medium-voltage facilities.

The best way to limit SF₆ emissions is to limit the use of this gas, which has led manufacturers in the electrical equipment industry to seek alternatives to SF₆.

One promising alternative is the use of a gas mixture containing a small percentage of an active molecule, fluoronitrile, oxygen and carbon dioxide. For example, and without limitation, between 3% and 4% C₄F₇N, between 10% and 20% O₂ and between 75% and 90% CO₂. The percentages of the gas mixture must be precisely respected because they determine, in particular, the dielectric properties of the gas mixture as well as its performance over a wide range of temperatures, for example between −25° C. in winter and +50° C. in summer. Other gas mixtures are possible.

When this gas mixture is transported in liquefied form to facilities, the equipment in place faces difficulties in transferring said mixture from the storage device to the high-or medium-voltage electrical equipment.

This is because the liquid and gas phases of the mixture are intrinsically non-homogeneous in the storage device, given that at least two of the components of this gas mixture do not have the same properties.

A liquefied gas stored in a storage device consists of two phases, liquid and gaseous, in equilibrium with one another. This equilibrium implies that at a given temperature, a liquefied gas has a predetermined pressure and that this pressure varies with temperature according to a relationship known as the Clapeyron equation, the parameters of which are specific to each gas.

When the gas phase is drawn off from a bottle of liquefied gas, part of the liquid must be vaporized so as to regenerate the gas phase as it is used up in order to maintain the equilibrium.

Thus, the energy necessary to compensate for this loss must be supplied. If the energy is not sufficient and fast enough to gasify the liquid and thus regenerate the vapour phase, the temperature, flow rate and pressure drop.

One solution is to heat the cylinder by controlling the heating using the pressure in the cylinder.

In general, the heating techniques used to increase liquefied gas flow rates consist of heating the walls of the cylinder using a resistive heating element such as a heating belt, heating cord or heat transfer fluid circulation jacket.

Another heating technique used involves induction heating, for example using an induction belt.

Document FR3054018 describes a solution for homogenizing a dielectric insulating mixture in the storage device. This ensures that the concentration of the various compounds remains the same, regardless of the level of the mixture in the storage device and before the mixture is drawn off. The mixture can then be transferred via a transfer circuit to the high-or medium-voltage equipment without any loss of homogeneity. In particular, condensation of one or more of the gases in this mixture must be avoided. The known solution consists of:
heating the mixture in the storage device to obtain a homogeneous fluid inside the storage device;
sampling the homogeneous mixture inside the storage device;
raising the temperature of the mixture taken to between 65° C. and 90° C.; and
lowering the pressure of the mixture taken to between 0 bar and 12 bar, in particular so that the equipment can be filled at a pressure between 6 and 12 bar.

Such variations in temperature and pressure in the transfer circuit cause at least one unwanted by-product to appear, which will also crystallize when the temperature drops as a result of the drop in pressure. This damages the equipment or limits the useful flow rate for distributing the gas mixture to high-or medium-voltage electrical equipment.

### SUMMARY

The present invention aims to effectively remedy these drawbacks by proposing a system for distributing a mixture to an enclosure, for example an electrical equipment enclosure, the system comprising:
a transfer circuit designed to be fluidically connected by one of its ends to a source of a mixture such as a single-phase mixture in the gas or supercritical phase, the mixture comprising, for example, a dielectric insulator, the transfer circuit also being designed to be connected by another of its ends to the enclosure;
a first heating element, configured to allow the mixture to be heated in the transfer circuit;
a second heating element, configured to allow the mixture to be heated in the transfer circuit;
a first expansion element, configured to allow the mixture to expand in the transfer circuit, for example so that the pressure of the mixture in the transfer circuit is reduced by a value of between 10 bar and 60 bar;
a second expansion element, configured to allow the mixture to expand in the transfer circuit, for example so that the pressure of the mixture in the transfer circuit is reduced by a value of between 10 bar and 60 bar;
a third expansion element, configured to allow the mixture to expand in the transfer circuit, for example so that the pressure of the mixture in the transfer circuit is reduced by a value of between 10 bar and 60 bar;
the system being configured so that, in the direction of flow of the mixture in the transfer circuit, the mixture is successively heated by the first heating element, expanded by the first expansion element, heated by the second heating element, expanded by the second expansion element and expanded by the third expansion element.

The invention thus makes it possible, starting from a source of a mixture, in particular a single-phase mixture in the gas or supercritical phase, to transfer this mixture to high- or medium-voltage equipment without loss of homogeneity, while limiting the creation of by-products of the mixture and the crystallization of at least one of the by-products, and thereby the degradation of the performance of a component such as an expansion or flow control element.

The invention is particularly useful when the mixture contains CO₂. This is because, when it expands, CO₂ absorbs a lot of energy and therefore causes significant cooling, which in turn causes one or more by-products to crystallize.

According to one embodiment, the first heating element is configured to heat the mixture in the transfer circuit so that the temperature of the mixture in the transfer circuit is increased by a predetermined value of between 15° C. and 40° C., and the second heating element is configured to heat the mixture in the transfer circuit so that the temperature of the mixture in the transfer circuit is increased by a predetermined value of between 15° C. and 40° C.

According to one embodiment, the system comprises a third heating element configured to allow the mixture in the transfer circuit to be heated, so that the temperature of the mixture in the transfer circuit is increased by a predetermined value of between 10° C. and 25° C.

According to one embodiment, the second expansion element and the third expansion element are fluidically connected to each other by a portion of the transfer circuit, the bodies of the second expansion element and the third expansion element being at least 5 cm apart, for example separated from each other by the portion, the portion having, for example, a passage cross-section for the mixture that is greater than the smallest passage cross-section of either the second expansion element or the third expansion element.

According to one embodiment, the mixture is associated with a specific thermodynamic diagram.

According to one embodiment, the mixture is single-phase and preferably homogeneous.

Such a mixture is homogeneous when its various components and/or elemental gases are homogeneous at the source.

According to one embodiment, the source of a single-phase mixture is obtained from a non-homogeneous and/or at least two-phase mixture.

According to one embodiment, the thermodynamic diagram is an enthalpy diagram such as a Mollier diagram.

According to one embodiment, the electrical equipment is electrical equipment for a high-or medium-voltage power transmission line or electrical equipment for a high-or medium-voltage distribution substation.

According to one embodiment, the mixture comprises an insulating gas such as a dielectric insulator.

According to one embodiment, the mixture comprises carbon dioxide.

According to one embodiment, the mixture comprises an insulating gas such as a dielectric insulator and carbon dioxide in specific proportions.

According to one embodiment, the mixture comprises fluorinated nitrile such as (CF₃)₂CFCN and carbon dioxide in specific proportions.

According to one embodiment, the mixture comprises CO₂ and fluorinated nitrile, for example the mixture comprises from 2 mol % to 10 mol % of fluorinated nitrile, in particular from 3.5 mol % to 3.8 mol % of fluorinated nitrile, preferably 3.5 mol % or 3.8 mol % of fluorinated nitrile.

According to one embodiment, the system comprises a storage device containing a fluid comprising, for example, a dielectric insulator, the fluid being in the liquid, gas or supercritical phase in the storage device.

According to one embodiment, the storage device is configured to allow the fluid to be stored in a liquid/gas phase or in a pure gas phase or in a supercritical phase in the storage device.

According to one embodiment, the system comprises a heating element for the storage device configured to allow the fluid in the storage device to be heated, for example to cause the mixture to change from a liquid phase to a gas phase or to a supercritical phase and/or to maintain the fluid in a gas phase or in a supercritical phase.

According to one embodiment, the transfer circuit is fluidically connected to the storage device, allowing a portion of the fluid in the gas or supercritical phase to flow from the storage device into the transfer circuit, for example by acting as the source of the mixture in the gas or supercritical phase for the system.

According to one embodiment, the system includes a valve or tap configured to selectively fluidically isolate the storage device from the transfer circuit or to fluidically connect the storage device and the transfer circuit, so that a portion of the fluid in the gas or supercritical phase flows from the storage device into the transfer circuit.

According to one embodiment, the system is configured to keep the volume of the storage device occupied by the fluid constant, to allow it to pass into the supercritical phase when its temperature is increased.

According to one embodiment, the system is configured to keep the volume of the storage device occupied by the fluid constant, to allow it to pass into the pure gas phase when its temperature is increased.

According to one embodiment, the heating element of the storage device comprises an induction heater such as an induction belt.

According to one embodiment, the heating element of the storage device comprises electromagnetic induction and/or microwave means capable of heating the fluid inside the storage means.

According to one embodiment, the storage device comprises a thermal insulation enclosure such as an insulating box.

According to one embodiment, the transfer circuit comprises a pipe, for example, lined with a thermally insulating wall.

According to one embodiment, the first heating element comprises a heat exchanger such as a coil exchanger and/or a plate exchanger and/or an immersion exchanger.

According to one embodiment, the second heating element comprises a heat exchanger such as a coil exchanger and/or a plate exchanger and/or an immersion exchanger.

According to one embodiment, the third heating element comprises a heat exchanger such as a coil exchanger and/or a plate exchanger and/or an immersion exchanger.

According to one embodiment, the first heating element and the second heating element belong to the same heating device, which is configured, for example, to exchange heat with the transfer circuit on two different sections.

According to one variant, the first heating element and the second heating element belong to two separate heating devices.

According to one embodiment, the first expansion element comprises a pressure reducer and/or an expansion valve and/or a pressure regulator.

According to one embodiment, the second expansion element comprises a pressure reducer and/or an expansion valve and/or a pressure regulator.

According to one embodiment, the third expansion element comprises a pressure reducer and/or an expansion valve and/or a pressure regulator.

According to one embodiment, the expansion valve comprises a diaphragm expansion valve and/or a membrane expansion valve and/or a dome expansion valve and/or a piston expansion valve.

According to one embodiment, the system comprises a valve or tap to enable the source of the transfer circuit to be selectively isolated from the fluid flow.

The invention also relates to a method for distributing a mixture from a source to an enclosure, for example an electrical equipment enclosure, the method comprising the following steps:
a) providing a source of a mixture such as a single-phase mixture in the gas or supercritical phase, the mixture comprising, for example, a dielectric insulator;
b) transferring the mixture from the source to the enclosure via a transfer circuit fluidically connecting the source to the enclosure;
c) heating the mixture in the transfer circuit via a first heating element, the mixture having, upstream of the first heating element in the transfer circuit, an inlet temperature and an inlet pressure, step c) of heating being carried out so that the temperature of the mixture, downstream of said first heating element, in the transfer circuit, reaches a first predetermined temperature, the first predetermined temperature being higher than the inlet temperature, step c) of heating being carried out, for example, during step b) of transfer;
d) expanding the mixture heated in step c) of heating via a first expansion element until the pressure of the mixture downstream of the first expansion element in the transfer circuit is equal to a first predetermined pressure, the first predetermined pressure being, for example, reduced by a value of between 10 bar and 60 bar relative to the inlet pressure, the temperature of the mixture downstream of the expansion element in the transfer circuit thus reaching a second temperature, the second temperature being lower than the first predetermined temperature, step d) of expansion being, for example, carried out during step b) of transfer;
e) heating the mixture expanded in step d) of expansion, in the transfer circuit, via the second heating element, so that the temperature of the mixture, downstream of said second heating element, in the transfer circuit, reaches a third predetermined temperature, the third predetermined temperature being higher than the second temperature, step e) of heating being carried out, for example, during step b) of transfer;
f) expanding the mixture heated in step e) of heating, via a second expansion element, until the pressure of the mixture in the transfer circuit, downstream of the second expansion element, is equal to a second predetermined pressure, the second predetermined pressure being, for example, reduced by a value of between 10 bar and 60 bar relative to the first predetermined pressure, step f) of expansion being, for example, carried out during step b) of transfer;
g) expanding the mixture expanded in step f) of expansion via a third expansion element until the pressure of the mixture downstream of the third expansion element in the transfer circuit is equal to a third predetermined pressure, the third predetermined pressure being, for example, reduced by a value of between 10 bar and 60 bar relative to the second predetermined pressure, step g) of expansion being, for example, carried out during step b) of transfer.

According to one embodiment, the process comprises the step of: h) heating the mixture expanded in step f) of expansion via a third heating element so that the temperature of the mixture downstream of said third heating element in the transfer circuit reaches a fourth predetermined temperature, the fourth predetermined temperature being higher than the third predetermined temperature, step h) of heating being carried out before or during step g) of expansion, step h) of heating being carried out, for example, during step b) of transfer.

According to one embodiment, the inlet temperature is between 20° C. and 40° C., for example between 25° C. and 35° C., and/or the first predetermined temperature is between 45° C. and 70° C., for example between 50° C. and 65° C., and/or the second predetermined temperature being between 45° C. and 70° C., for example between 50° C. and 65° C.

According to one embodiment, in step c) of heating, the temperature of the mixture in the transfer circuit is increased by a predetermined value of between 15° C. and 40° C. and/or in step e) of heating, the temperature of the mixture in the transfer circuit is increased by a predetermined value of between 15° C. and 40° C.

According to one embodiment, in step c) of heating, the first predetermined temperature is between 20% and 120% higher than the inlet temperature.

According to one embodiment, the fourth predetermined temperature is between 20° C. and 50° C.

According to one embodiment, in step h) of heating, the temperature of the mixture in the transfer circuit is increased by a value of between 10° C. and 25° C.

According to one embodiment, the values of the first predetermined temperature and/or third predetermined temperature and/or fourth predetermined temperature and/or first predetermined pressure and/or second predetermined pressure and/or third predetermined pressure are calculated based on the thermodynamic diagram predetermined so that the characteristics of the mixture in the transfer circuit remain away from the condensation curve of said thermodynamic diagram.

According to one embodiment, the process includes a step of calculating the values of the first predetermined temperature and/or third predetermined temperature and/or fourth predetermined temperature and/or first predetermined pressure and/or second predetermined pressure and/or third predetermined pressure, based on the predetermined thermodynamic diagram so that the characteristics of the mixture in the transfer circuit remain away from the condensation curve of said thermodynamic diagram.

According to one embodiment, the process comprises a step of heating the fluid in the storage device to a temperature such that the contents of the storage device are a homogeneous fluid, in particular in the gas or supercritical phase.

According to one embodiment, during step b) of transfer, a variable pressure control setpoint is applied, calculated in real time from the weight of the storage medium, when the variation in the pressure setpoint is less than 0.2 bar per 1 kg/m3 of variation in density, then a constant temperature control setpoint is applied until the storage medium is emptied of its contents.

According to one embodiment, the fluid heating step consists of heating the fluid until it reaches a gas or supercritical phase, for example up to a predetermined temperature based on the thermodynamic diagram predetermined so that the characteristics of the fluid in the storage device remain away from the condensation curve of said thermodynamic diagram.

According to one embodiment, the storage device is fluidically isolated from the transfer circuit during the fluid heating step.

According to one embodiment, at the end of the fluid heating step, the pressure inside the storage means is between 40 bar and 120 bar.

According to one embodiment, during step b) of transfer, the flow rate of the mixture in the transfer circuit is between 6 Nm³/h and 50 Nm³/h, preferably between 10 Nm³/h and 25 Nm³/h.

According to one embodiment, during step g) of expansion, the third pressure predetermined is equal to a predetermined enclosure filling pressure.

The invention may also relate to any alternative device or method comprising any combination of the features given above or below.

### BRIEF DESCRIPTION OF THE DRAWING

The invention will be better understood on reading the following description and on studying the accompanying figure. This figure is given only by way of illustration and does not in any way limit the invention.

FIG. 1 is a schematic depiction of a system according to the invention.

### DETAILED DESCRIPTION OF THE PREFERRED EMBODIMENTS

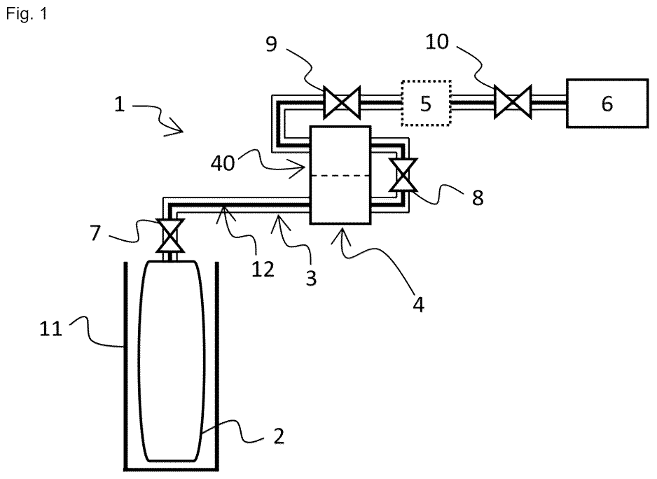

With reference to FIG. 1, a system 1 for distributing a mixture to an enclosure 6, for example an enclosure 6 of electrical equipment, is shown.

In one exemplary embodiment, the electrical equipment is electrical equipment for a high-or medium-voltage power transmission line or electrical equipment for a high-or medium-voltage distribution substation.

In one exemplary embodiment, the mixture comprises an insulating gas such as a dielectric insulator and also comprises carbon dioxide, the insulating gas and the carbon dioxide being in specific proportions.

In one exemplary embodiment, the mixture comprises fluorinated nitrile such as (CF3)2CFCN and carbon dioxide in specific proportions.

The system 1 comprises:
a transfer circuit 3 designed to be fluidically connected by one of its ends to a source 12 of a mixture such as a single-phase mixture in the gas or supercritical phase, the mixture comprising, for example, a dielectric insulator, the transfer circuit 3 being further designed to be connected by another of its ends to the enclosure 6;
a first heating element 4, configured to allow the mixture to be heated in the transfer circuit 3;
a second heating element 40, configured to allow the mixture in the transfer circuit 3 to be heated;
a first expansion element 8, configured to allow the mixture in the transfer circuit 3 to expand, for example so that the pressure of the mixture in the transfer circuit 3 is reduced by a value of between 10 bar and 60 bar;
a second expansion element 9, configured to allow the mixture in the transfer circuit 3 to expand, for example so that the pressure of the mixture in the transfer circuit 3 is reduced by a value of between 10 bar and 60 bar;
a third expansion element 10, configured to allow the mixture in the transfer circuit 3 to expand, for example so that the pressure of the mixture in the transfer circuit 3 is reduced by a value of between 10 bar and 60 bar.

The system 1 is configured so that, in the direction of flow of the mixture in the transfer circuit 3, the mixture is successively heated by the first heating element 4, expanded by the first expansion element 8, heated by the second heating element 40, expanded by the second expansion element 9 and expanded by the third expansion element 10.

The first heating element 4 is configured to allow the mixture in the transfer circuit 3 to be heated so that the temperature of the mixture in the transfer circuit 3 is increased by a predetermined value of between 15° C. and 40° C.

The second heating element 40 is configured to allow the mixture in the transfer circuit 3 to be heated so that the temperature of the mixture in the transfer circuit 3 is increased by a predetermined value of between 15° C. and 40° C.

In one exemplary embodiment, the system 1 comprises a third heating element 5 configured to heat the mixture in the transfer circuit 3 so that the temperature of the mixture in the transfer circuit is increased by a predetermined value of between 10° C. and 25° C.

The second expansion element 9 and the third expansion element 10 are fluidically connected to each other by a portion of the transfer circuit 3.

The bodies of the second expansion element 9 and third expansion element 10 are spaced at least 5 cm apart, for example spaced apart by the portion, the portion having, for example, a passage cross-section for the mixture that is greater than the smallest passage cross-section of either the second expansion element 9 or the third expansion element 10.

In one exemplary embodiment, the system 1 comprises a storage device 2 containing a fluid comprising, for example, a dielectric insulator, the fluid being in a liquid, gas or supercritical phase in the storage device.

The storage device 2 is configured to allow the fluid to be stored in the liquid/gas phase or in the pure gas phase or in the supercritical phase in the storage device.

The system 1 comprises a heating element 11 for the storage device 2, configured to allow the fluid in the storage device to be heated, for example to cause the mixture to change from a liquid phase to a gas phase or to a supercritical phase and/or to maintain the fluid in a gas phase or in a supercritical phase.

The transfer circuit 3 is fluidically connected to the storage device 2, allowing a portion of the fluid in the gas or supercritical phase to flow from the storage device 2 into the transfer circuit 3, for example by acting as the source 12 of the mixture in the gas or supercritical phase for the system 1.

The system 1 comprises a valve 7 and/or a tap configured to selectively fluidically isolate the storage device 2 from the transfer circuit 3 or to fluidically connect the storage device 2 and the transfer circuit 3, so that a portion of the fluid in the gas or supercritical phase flows from the storage device 2 into the transfer circuit 3.

When the valve 7 or the tap is open, the mixture, in the supercritical phase or in the pure gas phase in the container, passes into transfer circuit 3 where it is capable of cooling by Joule-Thomson expansion.

The system 1 is configured to keep the volume of the storage device 2 occupied by the fluid constant, to allow it to pass into the supercritical phase when its temperature is increased.

The system 1 is configured to keep the volume of the storage device 2 occupied by the fluid constant, to allow it to pass into the pure gas phase when its temperature is increased.

The heating element 11 of the storage device comprises an induction heater such as an induction belt.

The heating element 11 of the storage device comprises electromagnetic induction and/or microwave means capable of heating the fluid inside the storage means 2.

The storage device 2 comprises a thermal insulation enclosure such as an insulating box.

The transfer circuit 3 comprises a pipe, for example lined with a thermally insulating wall.

A method for distributing a mixture from a source 12 to an enclosure 6, for example an enclosure 6 of electrical equipment, is described below.

In one exemplary embodiment, such a method is carried out using the system 1 described in FIG. 1.

The method comprises the following steps:
a) providing a source 12 of a mixture such as a single-phase mixture in the gas or supercritical phase, the mixture comprising, for example, a dielectric insulator;
b) transferring the mixture from the source 12 to the enclosure 6 via a transfer circuit 3, fluidically connecting the source 12 to the enclosure 6;
c) heating the mixture in the transfer circuit 3 via a first heating element 4, the mixture having, upstream of the first heating element 4 in the transfer circuit 3, an inlet temperature and an inlet pressure, step c) of heating being carried out so that the temperature of the mixture, downstream of said first heating element 4, in the transfer circuit, reaches a first predetermined temperature, the first predetermined temperature being higher than the inlet temperature, step c) of heating being carried out, for example, during step b) of transfer;
d) expanding the mixture heated in step c) of heating via a first expansion element 8 until the pressure of the mixture downstream of the first expansion element 8 in the transfer circuit 3 is equal to a first predetermined pressure, the first predetermined pressure being, for example, reduced by a value of between 10 bar and 60 bar relative to the inlet pressure, the temperature of the mixture downstream of the expansion element 8 in the transfer circuit 3 thus reaching a second temperature, the second temperature being lower than the first predetermined temperature, step d) of expansion being, for example, carried out during step b) of transfer;
e) heating the mixture expanded in step d) of expansion in the transfer circuit 3 via the second heating element 40, so that the temperature of the mixture downstream of said second heating element 40 in the transfer circuit 3 reaches a third predetermined temperature, the third predetermined temperature being higher than the second temperature, step e) of heating being carried out, for example, during step b) of transfer;
f) expanding the mixture heated in step e) of heating, via a second expansion element 9, until the pressure of the mixture in the transfer circuit 3, downstream of the second expansion element 8, is equal to a second predetermined pressure, the second predetermined pressure being, for example, reduced by a value of between 10 bar and 60 bar with respect to the first predetermined pressure, step f) of expansion being, for example, carried out during step b) of transfer;
g) expanding the mixture expanded in step f) of expansion via a third expansion element 10 until the pressure of the mixture downstream of the third expansion element 8 in the transfer circuit 3 is equal to a third predetermined pressure, the third predetermined pressure being, for example, reduced by a value of between 10 bar and 60 bar relative to the second predetermined pressure, step g) of expansion being, for example, carried out during step b) of transfer.

The method comprises the step of: h) heating the mixture expanded in step f) of expansion via a third heating element 5, so that the temperature of the mixture downstream of said third heating element 5 in the transfer circuit 3 reaches a fourth predetermined temperature, the fourth predetermined temperature being higher than the third predetermined temperature, step h) of heating being carried out before or during step g) of expansion, step h) of heating being carried out, for example, during step b) of transfer.

The inlet temperature is between 20° C. and 40° C., for example between 25° C. and 35° C., and/or the first predetermined temperature being between 45° C. and 70° C., for example between 50° C. and 65° C., and/or the second predetermined temperature being between 45° C. and 70° C., for example between 50° C. and 65° C.

In step c) of heating, the temperature of the mixture in the transfer circuit 3 is increased by a predetermined value of between 15° C. and 40° C. and/or in heating step e), the temperature of the mixture in the transfer circuit is increased by a predetermined value of between 15° C. and 40° C.

In one exemplary embodiment, the system 1 comprises a computing unit for implementing the above-described process.

In one exemplary embodiment, the filling pressure of the enclosure 6 is set at 10 bar. When the pressure obtained during step g) of expansion is sufficient, filling takes place directly, so expansion continues between the downstream side of the third expansion element 10 and the enclosure 6. The pressure in the enclosure 6 gradually increases. When the pressure as caused by step g) of expansion is no longer sufficient, a final compression step via a final compressor allows the pressure of the mixture to be raised to reach the filling pressure of the enclosure 6.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

What is claimed is:

1. A system (1) for distributing a mixture to an enclosure (6), the system (1) comprising:
a transfer circuit (3) designed to be fluidically connected by one of its ends to a source (12) of a single-phase mixture in the gas or supercritical phase, the mixture comprising, a dielectric insulator, the transfer circuit (3) also being designed to be connected by another of its ends to the enclosure (6);
a first heating element (4), configured to allow the single-phase mixture in the transfer circuit (3) to be heated;
a second heating element (40), configured to allow the single-phase mixture in the transfer circuit (3) to be heated;
a first expansion element (8), configured to allow the single-phase mixture in the transfer circuit (3) to expand, so that the pressure of the single-phase mixture in the transfer circuit (3) is reduced;
a second expansion element (9), configured to allow the single-phase mixture in the transfer circuit (3) to expand, so that the pressure of the single-phase mixture in the transfer circuit (3) is reduced;
a third expansion element (10), configured to allow the single-phase mixture in the transfer circuit (3) to expand, so that the pressure of the single-phase mixture in the transfer circuit (3) is reduced;
the system (1) being configured so that, in the direction of flow of the single-phase mixture in the transfer circuit (3), the single-phase mixture is successively heated by the first heating element (4), expanded by the first expansion element (8), heated by the second heating element (40), expanded by the second expansion element (9) and expanded by the third expansion element (10).

2. The system (1) according to claim 1, characterized in that the first heating element (4) is configured to heat the single-phase mixture in the transfer circuit (3) so that the temperature of the single-phase mixture in the transfer circuit (3) is increased by a predetermined value of between 15° C. and 40° C., and in that the second heating element (40) is configured to heat the single-phase mixture in the transfer circuit (3) so that the temperature of the single-phase mixture in the transfer circuit (3) is increased by a predetermined value of between 15° C. and 40° C.

3. The system (1) according to claim 2, comprising a third heating element (5) configured to allow the single-phase mixture in the transfer circuit (3) to be heated, so that the temperature of the single-phase mixture in the transfer circuit is increased by a predetermined value of between 10° C. and 25° C.

4. The system (1) according to claim 1, wherein the second expansion element (9) and the third expansion element (10) being fluidically connected to each other by a portion of the transfer circuit (3), the bodies of the second expansion element (9) and the third expansion element (10) being at least 5 cm apart, and separated from each other by the portion, the portion having, a passage cross-section for the single-phase mixture that is greater than the smallest passage cross-section of either the second expansion element (9) or the third expansion element (10).

5. A method for distributing a single-phase mixture from a source (12) to an enclosure (6), the method comprising the following steps:
a) providing a source (12) of a single-phase mixture in a gas or supercritical phase, the single-phase mixture comprising, a dielectric insulator;
b) transferring the single-phase mixture from the source (12) to the enclosure (6) via a transfer circuit (3), fluidically connecting the source (12) to the enclosure (6);
c) heating the single-phase mixture in the transfer circuit (3) via a first heating element (4), the single-phase mixture having, upstream of the first heating element (4) in the transfer circuit (3), an inlet temperature and an inlet pressure, step c) of heating being carried out so that the temperature of the single-phase mixture, downstream of said first heating element (4), in the transfer circuit, reaches a first predetermined temperature, the first predetermined temperature being higher than the inlet temperature, step c) of heating being carried out, during step b);
d) expanding the mixture heated in step c) via a first expansion element (8) until the pressure of the single-phase mixture downstream of the first expansion element (8) in the transfer circuit (3) is equal to a first predetermined pressure, the first predetermined pressure being, reduced, the temperature of the single-phase mixture downstream of the expansion element (8) in the transfer circuit (3) thus reaching a second temperature, the second temperature being lower than the first predetermined temperature, wherein step d) is carried out during step b);
e) heating the single-phase mixture expanded in step d) via the second heating element (40), so that the temperature of the single-phase mixture downstream of said second heating element (40) in the transfer circuit (3) reaches a third predetermined temperature, the third predetermined temperature being higher than the second temperature, step e) being carried out during step b);
f) expanding the single-phase mixture heated in step e), via a second expansion element (9), until the pressure of the single-phase mixture in the transfer circuit (3), downstream of the second expansion element (8), is equal to a second predetermined pressure, the second predetermined pressure being, reduced relative to the first predetermined pressure, step f) being carried out during step b);
g) expanding the single-phase mixture expanded in step f) via a third expansion element (10) until the pressure of the single-phase mixture downstream of the third expansion element (8) in the transfer circuit (3) is equal to a third predetermined pressure, the third predetermined pressure being reduced by a value relative to the second predetermined pressure, step g) being carried out during step b).

6. The method according to claim 5, further comprising the step of: h) heating the single-phase mixture expanded in step f) via a third heating element (5), so that the temperature of the single-phase mixture downstream of said third heating element (5) in the transfer circuit (3) reaches a fourth predetermined temperature, the fourth predetermined temperature being higher than the third predetermined temperature, step h) being carried out during step b) and before or during step g).

7. The method according to claim 5, wherein an inlet temperature is between 20° C. and 40° C., and/or the first predetermined temperature is between 45° C. and 70° C., and/or the second predetermined temperature is between 45° C. and 70° C.

8. The method according to claim 5, in step c) of heating, the temperature of the mixture in the transfer circuit (3) is increased by a predetermined value of between 15° C. and 40° C. and/or in heating step e), the temperature of the mixture in the transfer circuit is increased by a predetermined value of between 15° C. and 40° C.
